(19) United States
(12) Patent Application Publication
(10) Pub. No.: US 2024/0084684 A1
(43) Pub. Date: Mar. 14, 2024

(54) SYSTEMS AND METHODS FOR GENERATING A STRESS SHADOW EFFECT IN A SUBSURFACE VOLUME OF INTEREST

(71) Applicant: CHEVRON U.S.A. INC., San Ramon, CA (US)

(72) Inventors: Shane James Prochnow, Fredericksburg, TX (US); Paymon Pourmoradi Hossaini, Cypress, TX (US); Mohamed Ibrahim Hafez Mohamed, Houston, TX (US); Alena Grechishnikova, Midland, TX (US); Sandra Christine Saldana, Houston, TX (US)

(21) Appl. No.: 18/462,293

(22) Filed: Sep. 6, 2023

Related U.S. Application Data
(60) Provisional application No. 63/404,485, filed on Sep. 7, 2022.

(51) Int. Cl. E21B 43/26; E21B 47/022

(52) U.S. Cl. CPC E21B 43/2607; E21B 47/022

(57) ABSTRACT

Systems and methods are disclosed for generating a stress shadow effect as a function of position in a subsurface volume of interest. A computer-implemented method may obtain completion data in the subsurface volume of interest; generate relationships between the hydraulic fracturing stage data and the corresponding wellbore distances; and generate spatially discrete stress shadow effect data by spatially attributing the stress shadow effect slope coefficient to locations of the individual wells.

### CROSS-REFERENCE TO RELATED APPLICATION

This application claims priority to U.S. Provisional Application No. 63/404,485, filed on Sep. 7, 2022, the contents of which is hereby incorporated by reference in its entirety.

### FIELD OF THE DISCLOSURE

The present disclosure relates to generating a stress shadow effect in a subsurface volume of interest.

### BACKGROUND

Previous approaches to examine the impact of a stress shadow effect have relied on complex geomechanical simulation modeling that itself requires measurements that are often difficult and costly to obtain. Therefore, there is a need in the area of stress shadow effect.

### SUMMARY

Implementations of the present disclosure are directed to systems and methods for generating a stress shadow effect in a subsurface volume of interest. In one implementation, the method may be implemented on a computer system. For example, the computer system may include a stress shadow detection circuit and non-transient electronic storage. The computer-implemented method may include obtaining completion data in the subsurface volume of interest from the non-transient electronic storage. The completion data may include hydraulic fracturing stage data and corresponding wellbore distances as a function of position. Individual sets of the corresponding wellbore distances may correspond to individual wells. The computer-implemented method may include generating relationships between the hydraulic fracturing stage data and the corresponding wellbore distances. Each of the relationships may include a stress shadow effect slope coefficient representing an effect that fracturing a wellbore has on the subsurface volume of interest. The computer-implemented method may include generating spatially discrete stress shadow effect data by spatially attributing the stress shadow effect slope coefficient to locations of the individual wells. The spatially discrete stress shadow effect data may specify the effect fracturing the wellbore is having on the subsurface volume of interest as a function of position.

In accordance with aspects of the technology disclosed herein, the computer-implemented method may include generating spatially continuous stress shadow effect data by using at least the spatially discrete stress shadow effect data to estimate stress shadow effect data between the spatially discrete stress shadow effect data.

In implementations, the computer-implemented method may further include generating a representation of the stress shadow effect as a function of position in the subsurface volume of interest using visual effects to depict at least a portion of the spatially continuous stress shadow effect data. The computer-implemented method may further include displaying the representation in a graphical user interface.

In implementations, generating the spatially continuous stress shadow effect data may include interpolation.

In implementations, generating multiple completion efficiency values may include a ratio between the refined reservoir productivity values and corresponding well designs.

In implementations, the hydraulic fracturing stage data may specify a pressure value corresponding to a time at which the fluid pressure declines after injection.

In implementations, the relationships are generated using a stress shadow effect model.

In implementations, the stress shadow effect model comprises a regression analysis.

In other implementations, a system is disclosed. The system may include non-transient electronic storage and a stress shadow detection circuit configured by machine-readable instructions to perform a number of operations. One operation may include obtaining completion data in the subsurface volume of interest. The completion data may include hydraulic fracturing stage data and corresponding wellbore distances as a function of position. Individual sets of the corresponding wellbore distances may correspond to individual wells. Another operation may include generating relationships between the hydraulic fracturing stage data and the corresponding wellbore distances. Each of the relationships may include a stress shadow effect slope coefficient representing an effect that fracturing a wellbore has on the subsurface volume of interest. Yet another operation may include generating spatially discrete stress shadow effect data by spatially attributing the stress shadow effect slope coefficient to locations of the individual wells. The spatially discrete stress shadow effect data may specify the effect fracturing the wellbore is having on the subsurface volume of interest as a function of position.

In implementations, another operation may include generating spatially continuous stress shadow effect data by using at least the spatially discrete stress shadow effect data to estimate stress shadow effect data between the spatially discrete stress shadow effect data.

In implementations, the system may further include a graphical user interface. One of the operations may include generating a representation of the refined reservoir productivity values as a function of position in the subsurface volume of interest using visual effects to depict at least a portion of the refined reservoir productivity values. Another operation may include displaying the representation.

In implementations, the system may further include a graphical user interface. One operation may include generating a representation of the stress shadow effect as a function of position in the subsurface volume of interest using visual effects to depict at least a portion of the spatially continuous stress shadow effect data. One operation may include displaying the representation in the graphical user interface.

In implementations, generating the spatially continuous stress shadow effect data may include interpolation.

In implementations, the hydraulic fracturing stage data may specify a pressure value corresponding to a time at which the fluid pressure declines after injection.

In implementations, the relationships may be generated using a stress shadow effect model.

In implementations, the stress shadow effect model may include a regression analysis.

In other implementations, a non-transitory machine-readable storage media is disclosed. The non-transitory machine-readable storage media may store instructions that, when executed by a stress shadow detection circuit, cause the stress shadow detection circuit to perform a number of operations. One operation may include obtaining completion data in the subsurface volume of interest from the non-transient electronic storage. The completion data may include hydraulic fracturing stage data and corresponding wellbore distances as a function of position. Individual sets of the corresponding wellbore distances may correspond to individual wells. Another operation may include generating relationships between the hydraulic fracturing stage data and the corresponding wellbore distances. Each of the relationships may include a stress shadow effect slope coefficient representing an effect that fracturing a wellbore has on the subsurface volume of interest. Yet another operation may include generating spatially discrete stress shadow effect data by spatially attributing the stress shadow effect slope coefficient to locations of the individual wells. The spatially discrete stress shadow effect data may specify the effect fracturing the wellbore is having on the subsurface volume of interest as a function of position.

In implementations, another operation may include generating spatially continuous stress shadow effect data by using at least the spatially discrete stress shadow effect data to estimate stress shadow effect data between the spatially discrete stress shadow effect data.

In implementations, another operation may include generating a representation of the stress shadow effect as a function of position in the subsurface volume of interest using visual effects to depict at least a portion of the spatially continuous stress shadow effect data. Yet another operation may include displaying the representation in a graphical user interface.

In implementations, generating the spatially continuous stress shadow effect data may include interpolation.

In implementations, the hydraulic fracturing stage data may specify a pressure value corresponding to a time at which the fluid pressure declines after injection.

In implementations, the relationships may be generated using a stress shadow effect model, and wherein the stress shadow effect model comprises a regression analysis.

These and other features and characteristics of the present technology, as well as the methods of operation and functions of the related elements of structure and the combination of parts, will become more apparent upon consideration of the following description and the appended Claims with reference to the accompanying drawings, all of which form a part of this specification, wherein like reference numerals designate corresponding parts in the various figures. It is to be expressly understood, however, that the drawings are for the purpose of illustration and description and are not intended as a definition of the limits of the presently disclosed technology. As used in the specification and in the Claims, the singular form of “a”, “an”, and “the” include plural referents unless the context clearly dictates otherwise.

The technology disclosed herein, in accordance with various implementations, is described in detail with reference to the following figures. The drawings are provided for purposes of illustration and merely depict typical or example implementations of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

### BRIEF DESCRIPTION OF THE DRAWINGS

FIG. 1 shows a system configured for generating a stress shadow effect in a subsurface volume of interest, in accordance with some implementations.

FIG. 2 is a flowchart of a method of generating a stress shadow effect in a subsurface volume of interest, in accordance with some implementations.

FIG. 3 illustrates example linear relationships, in accordance with some implementations.

FIG. 4 is an example representation, in accordance with some implementations.

FIG. 5 illustrates a one-dimensional partial dependency of predictors, in accordance with some implementations.

FIG. 6 illustrates example computing component, in accordance with some implementations.

### DETAILED DESCRIPTION

In the following detailed description, numerous details may be set forth in order to provide a thorough understanding of the present disclosure and the implementations described herein. However, implementations described herein may be practiced without such details. In other instances, some methods, procedures, components, and mechanical apparatuses may not be described in detail, so as not to unnecessarily obscure aspects of the implementations.

In order to achieve commercial production from unconventional resources, including, for example, ultra-low permeability shale formations, horizontal wells may be used with multiple hydraulic fracture stages. The properties of the hydraulic fractures are impacted by the stress conditions during the fracturing and the production, and may impact the production performance of the horizontal well with multiple fractures. Hydraulic fractures may form due to injection volumes causing pressure on the wellbore and completion. This well pressure may alter the perforation or wellbore and may cause stress in the formation. These deformations and changes caused by the hydraulic fractures may be understood to be the stress shadow effect discussed herein. For example, the following relationship may describe how stress shadow influences instantaneous shut in pressure (ISIP) behavior and hydraulic fracture height:

$$Δ {σ}_{s h a d o w} ( n ) = Δ {σ}_{plateau} ( 1 - {e}^{1 - \frac{n}{e s c}} )$$

$$esc = 1.9 \; 28 \times {\frac{Sf}{2 h f}}^{- 1.36}$$

$$hf = S S \times CN \times {\frac{esc}{1.928}}^{\frac{1}{1.36}}$$

where Δσ_{shadow}(n) is the stress changed due to stress shadow per n-stages; Δσₚₗₐₜₑₐᵤ is the total stress change caused by stress shadow; esc is number of stages required for stress changed to reach a plateau; Sƒ is fracture stage spacing; and hƒ is fracture height.

Previous approaches to examine the impact of the stress shadow effect have relied on complex geomechanical simulation modeling that itself requires measurements that are often difficult and costly to obtain, such as dense geomechanical moduli and rock strength observations from wellbore logging and/or core analysis. As such, there is an opportunity to automatically generate a stress shadow proxy from completion data. Completion data includes hydraulic fracture stage estimates derived from a pressure profile chart, including instantaneous shut-in pressure, breakdown pressure, and fracture gradient.

The presently disclosed technology enables the automatic generation of the stress shadow effect from well completion observations. For example, the presently disclosed technology may leverage completion data in map space to generate slope coefficients used to represent the stress shadow effect. The slope coefficients may be derived from well- and/or pad-based regression trend analyses. The slope coefficients may be attributed to the corresponding wells to generate the stress shadow effect as a function of position. In implementations, the data may be further interpolated to form a grid of the stress shadow proxy that is displayed to a user. In some implementations, the stress shadow proxy may be used to better predict well productivity. The stress shadow proxy is the regression trend function slope, or the rate of change, of either instantaneous shut in pressure, breakdown pressure, closure stress, fracture gradient or any other reservoir or fracture pressure measurement incrementally captured as data during the sequential, incremental (stage) hydraulic fracture stimulation operation of the well.

Using the presently disclosed technology, the stress shadow effect can be estimated at an order-of-magnitude scale for awareness within asset development plans, and the stress shadow effect can also be used to rank stress shadow optimization opportunities for more detailed simulation work. As an example, subsurface machine learning may be used to determine the impact of stress shadow effect in predicting oil productivity. Moreover, the presently disclosed technology can be used to automatically identify anomalous stages tied to natural fractures and can be used to better explain fracture driven interaction.

Disclosed below are methods, systems, and computer readable storage media that may generate a stress shadow effect as a function of position in a subsurface volume of interest. A subsurface volume of interest may include any area, region, and/or volume underneath a surface. Such a volume may include, or be bounded by, one of a water surface, a ground surface, and/or another surface.

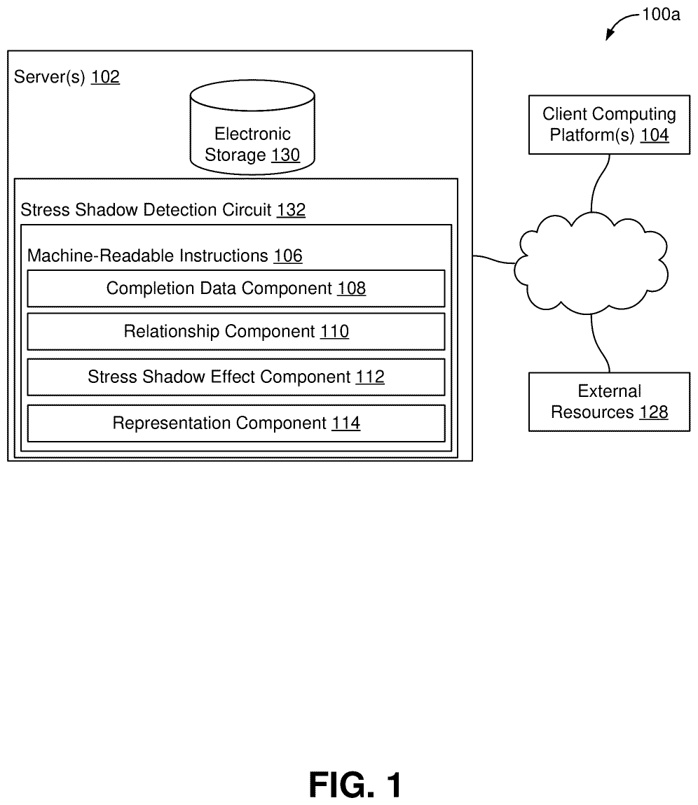

FIG. 1 illustrates a system 100 configured for generating a stress shadow effect in a subsurface volume of interest, in accordance with some implementations. In implementations, system 100 may generate a stress shadow effect in a subsurface volume of interest. In some implementations, system 100 may include a server 102. Server(s) 102 may be configured to communicate with a client computing platform 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include an instruction component. The instruction components may include computer program components. The instruction components may include one of a completion data component 108, a relationship component 110, a stress shadow effect component 112, a representation component 114, and/or other instruction components.

Completion data component 108 may be configured to obtain completion data in the subsurface volume of interest. This may be accomplished by a stress shadow detection circuit. The completion data may include hydraulic fracturing stage data and corresponding wellbore distances as a function of position. Hydraulic fracturing stage data may include stress, strain and/or pressure data generated during a hydraulic fracturing stage of well development. In some implementations, hydraulic fracturing stage data may include instantaneous shut in pressure data. The ISIP data may specify a pressure value corresponding to a time at which the fluid pressure declines after injection. In some implementations, the ISIP data may be collected at different fracture stages. Each fracture stage may represent fracturing more of a well in preparation for hydrocarbon extraction. For each fracture stage, the ISIP data and the corresponding wellbore distance may be measured or otherwise collected. In some implementations, each sequential fracture stage may indicate a further depth into the well. Fracturing may start at a toe, or end of the well, and work back to a start of the well. ISIP data may be collected by one or more sensors on fracturing equipment. While ISIP data is used as one example of hydraulic fracturing stage data, it should be appreciated that the above may apply to all hydraulic fracturing stage data.

Wellbore distances may be a distance from a start of the well to another point in the well. A given corresponding wellbore distance may correspond to the hydraulic fracturing stage data at a given fracture stage. It should be appreciated that an individual set of the corresponding wellbore distances may correspond to an individual well.

Relationship component 110 may be configured to generate relationships between the hydraulic fracturing stage data and the corresponding wellbore distances. This may be accomplished by a stress shadow detection circuit. The relationship may be generated using a stress shadow effect model. In some implementations, the stress shadow effect model may include a regression analysis, a machine learning model, geostatistics, and/or other techniques. Each of the relationships may be used to determine a stress shadow effect slope coefficient representing an effect that fracturing a wellbore has on the subsurface volume of interest. The stress shadow effect slope coefficient may be determined from the slope of the curve derived from the relationship. In some implementations, the stress shadow effect slope coefficient may be in units of psi per foot or a pressure unit per a distance unit. The effect that fracturing a wellbore has on the subsurface volume of interest may be the deformations and/or stresses in the formation caused by the fracturing of the well. For example, a higher stress shadow effect slope coefficient value may mean there is a greater deformation and/or stress in the formation caused by the fracturing of the well in that location.

In some implementations, the relationship between the hydraulic fracturing stage data and the corresponding wellbore distances may be a linear relationship, a non-linear relationship, and/or another relationship. For linear relationships, the slope of the line may be used to determine a stress shadow effect slope coefficient. For non-linear relationships, a derivative may be taken at a given point to determine the slope of the non-linear curve at a given point. The slope of the non-linear curve at the given point may be used to determine a stress shadow effect slope coefficient.

Stress shadow effect component 112 may be configured to generate spatially discrete stress shadow effect data. Each hydraulic fracture stage along the wellbore has definite beginning and end points (boundaries), that can be placed in a geodetic coordinate system and represented on a map as a discrete location with accompanying attribute information, like instantaneous shut-in pressure or any other lithology or completions related data within those spatial boundaries. This may be accomplished by a stress shadow detection circuit. Generating spatially discrete stress shadow effect data may include spatially attributing the stress shadow effect slope coefficient to locations of the individual wells. For example, this may be done by adding the stress shadow effect slope coefficient to metadata corresponding to the location of an individual well. Alternatively, the hydraulic fracturing stage data, the corresponding wellbore distances, and the stress shadow effect slope coefficient may be geotagged such that each of the hydraulic fracturing stage data, the corresponding wellbore distances, and the stress shadow effect slope coefficient correspond to a location of a given well. It should be appreciated these are examples of how the spatially discrete stress shadow effect data may be generated, and there are other methods that can be used. The spatially discrete stress shadow effect data may specify the effect fracturing the wellbore is having on the subsurface volume of interest as a function of position.

Stress shadow effect component 112 may be configured to generate spatially continuous stress shadow effect data. This may be accomplished by a stress shadow detection circuit. Generating spatially continuous stress shadow effect data may include using at least the spatially discrete stress shadow effect data to estimate stress shadow effect data at locations outside the wells corresponding to the spatially discrete stress shadow effect data. It should be appreciated that the spatially continuous stress shadow effect data may include the spatially discrete stress shadow effect data. For example, generating the spatially continuous stress shadow effect data may include interpolating, extrapolating, and/or other estimation techniques, including machine learning models. Interpolation may be used to fill in gaps of stress shadow effect data between the spatially discrete stress shadow effect data. In implementations, the interpolation may include using subsurface data and well data. The subsurface data and well data may be used to provide additional information in order to provide better interpolation results.

Interpolation techniques may include inexact and exact deterministic interpolation methods as well as stochastic-based geostatistical approaches. The deterministic approaches can include interpolation algorithms such as “inverse-distance-weighted” (exact) and “spline” (inexact) methods. Geostatistical approaches may include any kriging and co-kriging methods, the latter having the ability to incorporate other spatial data that is known to have spatial collinearity with the ISIP (or other fracture derivative) to improve and provide guidance in the interpolation process.

The subsurface data and/or the well data may be obtained from the non-transient electronic storage and/or other sources. The subsurface data may include geological data. Geological data may specify information on rocks in the subsurface volume of interest. For example, geological data may include petrophysical, core, cutting, pressure, drilling property, mudlog, seismic properties, average porosity, pore saturation, mineralogy, lithofacies, geomechanical properties, organic richness, and/or other geological data. In implementations, for unconventional reservoirs, this may include an anticipated stimulated rock volume, a natural geologic target zone, or a gross formation interval.

Well data may include engineering parameters and production data. Engineering parameters may specify characteristics of a well. For example, engineering parameters may include well perforation lengths, proppant intensity, fluid types, well spacing, number of fracture stages, a completion size, a proppant parameter value, a fracture fluid parameter value, a well spacing parameter, a well pump rate parameter, a casing perforation parameter, a perforation cluster spacing parameter, a completion stage length parameter, and/or other engineering parameters. Engineering parameters may include parameters that otherwise relate to well design and/or completion design. Production data may include cumulative oil, gas, and/or water production.

In some implementations, generating the spatially continuous stress shadow effect data may include extrapolation to fill in gaps of stress shadow effect data outside of the spatially discrete stress shadow effect data. In implementations, the extrapolation may include using subsurface data and well data, similar to how interpolation uses subsurface data and well data as described above. The subsurface data and well data may be used to provide additional information to provide better extrapolation results.

In some implementations, generating the spatially continuous stress shadow effect data may include machine learning models to fill in gaps of stress shadow effect data between and/or outside of the spatially discrete stress shadow effect data. In implementations, the machine learning model may include using subsurface data and well data. In an example, the machine learning model may use the spatially discrete stress shadow effect data, well data, subsurface data, completion data, stress shadow effect slope coefficients, and/or any other data as input. In some implementations, the machine learning model may be unsupervised. In implementations, the machine learning model may be supervised, and the output may be known spatially discrete stress shadow effect data.

Representation component 114 may be configured to generate a representation of the stress shadow effect as a function of position in the subsurface volume of interest. The representation may be generated using visual effects to depict at least a portion of the spatially continuous stress shadow effect data. This may be accomplished by a stress shadow detection circuit. In some implementations, a visual effect may include a visual transformation of the representation. A visual transformation may include a visual change in how the representation is presented or displayed. In some implementations, a visual transformation may include one of a visual zoom, a visual filter, a visual rotation, and/or a visual overlay (e.g., text and/or graphics overlay). The visual effect may include using a temperature map, or other color coding, to indicate which positions in the subsurface volume of interest have higher or lower values.

In some implementations, representation component 114 may be configured to display the representation. The representation may be displayed on a graphical user interface and/or other displays.

In some implementations, server(s) 102, client computing platform(s) 104, and/or external resources 128 may be operatively linked via an electronic communication link. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 128 may be operatively linked via some other communication media.

A given client computing platform 104 may include a stress shadow detection circuit configured to execute computer program components. The computer program components may be configured to enable an expert or user associated with the given client computing platform 104 to interface with system 100 and/or external resources 128, and/or provide other functionality attributed herein to client computing platform(s) 104. By way of non-limiting example, the given client computing platform 104 may include one of a desktop computer, a laptop computer, a handheld computer, a tablet computing platform, a NetBook, a Smartphone, and/or other computing platforms.

External resources 128 may include sources of information outside of system 100, external entities participating with system 100, and/or other resources. In some implementations, some or all of the functionality attributed herein to external resources 128 may be provided by resources included in system 100.

Server(s) 102 may include electronic storage 130, a stress shadow detection circuit 134, and/or another component. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 130 may comprise non-transient electronic storage and/or non-transitory storage media that electronically stores information. The electronic storage media of electronic storage 130 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 130 may include one of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by stress shadow detection circuit 132, information received from server(s) 102, information received from client computing platform(s) 104, and/or other information that enables server(s) 102 to function as described herein.

Stress shadow detection circuit 132 may be configured to provide information processing capabilities in server(s) 102. As such, stress shadow detection circuit 132 may include one of a physical computer processor, a digital processor, an analog processor, a digital circuit designed to process information, an analog circuit designed to process information, a state machine, and/or other mechanisms for electronically processing information. Although stress shadow detection circuit 132 is shown in FIG. 1 as a single entity, this is for illustrative purposes. In some implementations, stress shadow detection circuit 132 may include a plurality of processing units. These processing units may be physically located within the same device, or stress shadow detection circuit 132 may represent processing functionality of a plurality of devices operating in coordination. Stress shadow detection circuit 132 may be configured to execute components 108, 110, 112, 114, and/or other components. Stress shadow detection circuit 132 may be configured to execute components 108, 110, 112, 114, and/or other components by software; hardware; firmware; some combination of software, hardware, and/or firmware; and/or other mechanisms for configuring processing capabilities on stress shadow detection circuit 132. As used herein, the term “component” may refer to any component or set of components that perform the functionality attributed to the component. This may include a physical processor during execution of processor readable instructions, the processor readable instructions, circuitry, hardware, storage media, or any other components. As used herein, the term circuit might describe a given unit of functionality that can be performed in accordance with one or more embodiments of the present application. As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit.

It should be appreciated that although components 108, 110, 112, and/or 114 are illustrated in FIG. 1 as being implemented within a single processing unit, in implementations in which stress shadow detection circuit 132 includes multiple specialized processing units, one of components 108, 110, 112, and/or 114 may be implemented remotely from the other components. The description of the functionality provided by the different components 108, 110, 112, and/or 114 described below is for illustrative purposes, and is not intended to be limiting, as any of components 108, 110, 112, and/or 114 may provide more or less functionality than is described. For example, one of components 108, 110, 112, and/or 114 may be eliminated, and some or all of its functionality may be provided by other ones of components 108, 110, 112, and/or 114. As an example, stress shadow detection circuit 132 may be configured to execute an additional component that may perform some or all of the functionality attributed below to one of components 108, 110, 112, and/or 114.

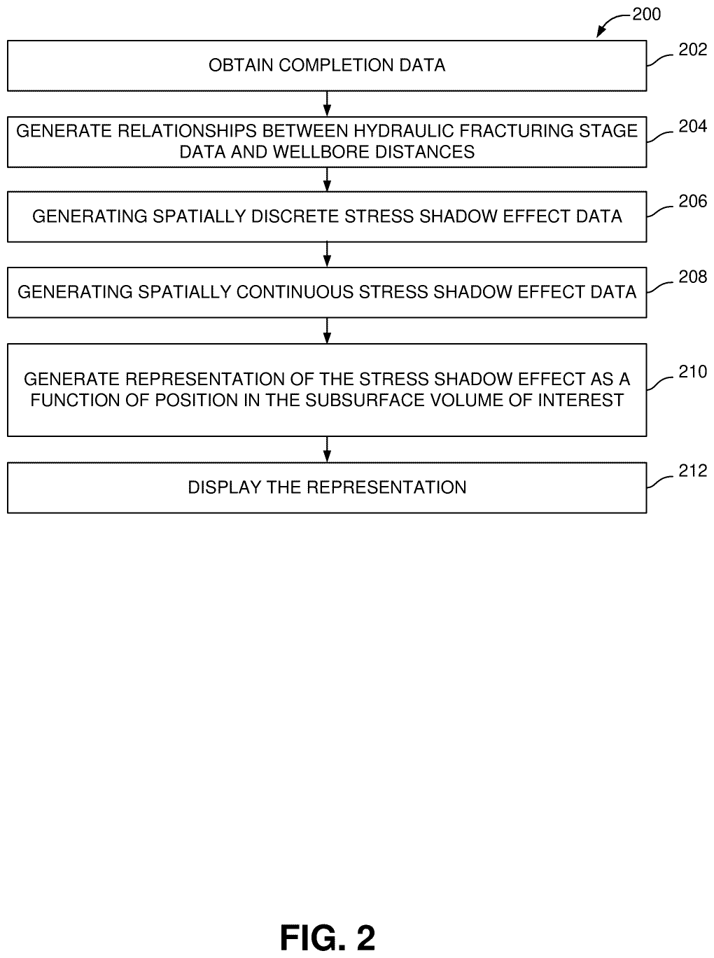

FIG. 2 illustrates a method 200 for generating a stress shadow effect in a subsurface volume of interest, in accordance with some implementations. The operations of method 200 presented below is intended to be illustrative. In some implementations, method 200 may be accomplished with an additional operation not described, and/or without one of the operations discussed. Additionally, the order in which the operations of method 200 is illustrated in FIG. 2 and described below is not intended to be limiting.

In some implementations, method 200 may be implemented in a stress shadow detection circuit (e.g., a digital processor, a physical computer processor, an analog processor, a digital circuit designed to process information, an analog circuit designed to process information, a state machine, and/or other mechanisms for electronically processing information). The stress shadow detection circuit may include a device executing some or all of the operations of method 200 in response to instructions stored electronically on an electronic storage medium. The stress shadow detection circuit may include a device configured through hardware, firmware, and/or software to be specifically designed for execution of one of the operations of method 200.

An operation 202 may include obtaining completion data in the subsurface volume of interest. As described above, the completion data may include instantaneous shut in pressure (ISIP) data and corresponding wellbore distances as a function of position. Operation 202 may be performed by a stress shadow detection circuit configured by machine-readable instructions including a component that is the same as or similar to completion data component 108, in accordance with some implementations.

An operation 204 may include generating relationships between instantaneous shut in pressure (ISIP) data and corresponding wellbore distances. As described above, each of the relationships may include a stress shadow effect slope coefficient representing an effect that fracturing a wellbore has on the subsurface volume of interest. The relationships may be generated using a stress shadow effect model. The stress shadow effect model may include a regression analysis, a machine learning model, geostatistics, and/or other techniques. As discussed above, the relationships may be linear, non-linear, and/or another type of relationship. Operation 204 may be performed by a stress shadow detection circuit configured by machine-readable instructions including a component that is the same as or similar to relationship component 110, in accordance with some implementations.

An operation 206 may include generating spatially discrete stress shadow effect data. Generating spatially discrete stress shadow effect data may include spatially attributing the stress shadow effect slope coefficient to locations of the individual wells. Operation 206 may be performed by a stress shadow detection circuit configured by machine-readable instructions including a component that is the same as or similar to stress shadow effect component 112, in accordance with some implementations.

An operation 208 may generating spatially continuous stress shadow effect data. Generating spatially continuous stress shadow effect data may include using at least the spatially discrete stress shadow effect data to estimate stress shadow effect data between the spatially discrete stress shadow effect data. Estimating the stress shadow effect data between and/or outside the spatially discrete stress shadow effect data may include interpolation, extrapolation, and/or other estimation techniques, including machine learning models. Operation 208 may be performed by a stress shadow detection circuit configured by machine-readable instructions including a component that is the same as or similar to stress shadow effect component 112, in accordance with some implementations.

An operation 210 may include generating a representation of the stress shadow effect as a function of position in the subsurface volume of interest. The representation may be generated by using visual effects to depict at least a portion of the spatially continuous stress shadow effect data. Operation 218 may be performed by a stress shadow detection circuit configured by machine-readable instructions including a component that is the same as or similar to representation component 114, in accordance with some implementations.

An operation 212 may include displaying the representation. Operation 220 may be performed by a stress shadow detection circuit configured by machine-readable instructions including a component that is the same as or similar to representation component 114, in accordance with some implementations.

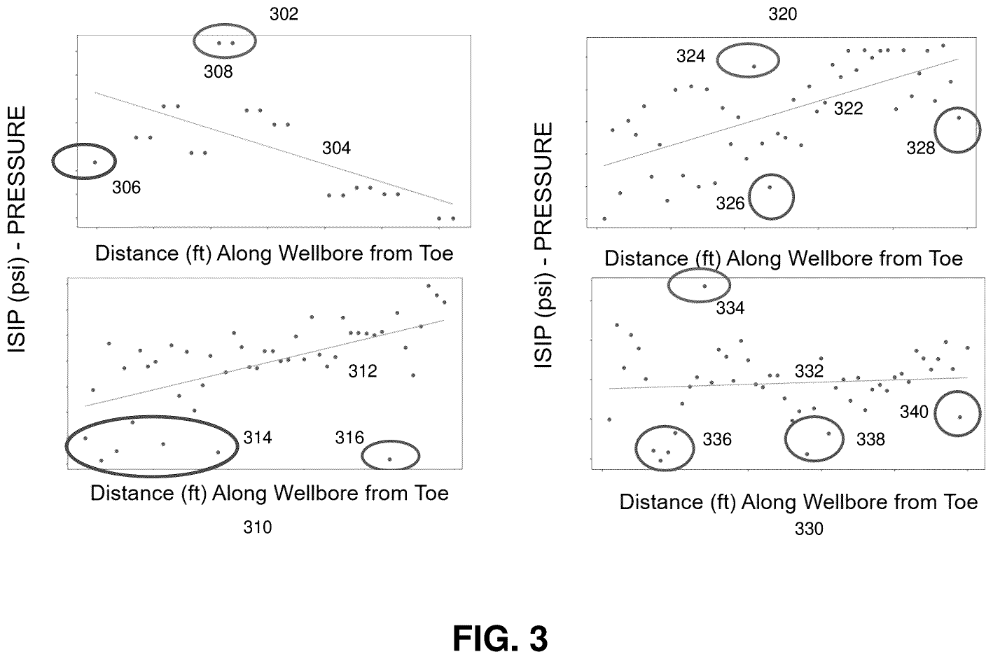

FIG. 3 illustrates example linear relationships, in accordance with some implementations. 302 is a graph of ISIP data and distances along a wellbore from a toe. The vertical axis is ISIP in pressure units, while the horizontal axis is distance along the wellbore from heel to toe. The regression trendlines illustrate the slope of ISIP buildup as the multi-stage hydraulic fracture operation progresses. Circled features represent stages deemed anomalies by an outlier analysis and should be interpreted further by combining with lithology and other reservoir context. These circled features may be removed from the analysis to generate the stress shadow effect. 302 may correspond to a single well along multiple fracture stages. 304 may represent a linear relationship of the ISIP data and the corresponding wellbore distances. 306 and 308 may represent outlier data. The outlier data may be explained as natural fractures, carbonate, and/or other subsurface features. 310, 320, and 330 are similar graphs of ISIP data and distances along a wellbore from a toe corresponding to different wells. 312, 322, and 332 also represent linear relationships between the ISIP data and the corresponding wellbore distances for the wells corresponding to 310, 320, and 330 respectively. 314, 316, 324, 326, 328, 334, 336, 338, and 340 also represent outlier data, similar to what is described above for 306 and 308.

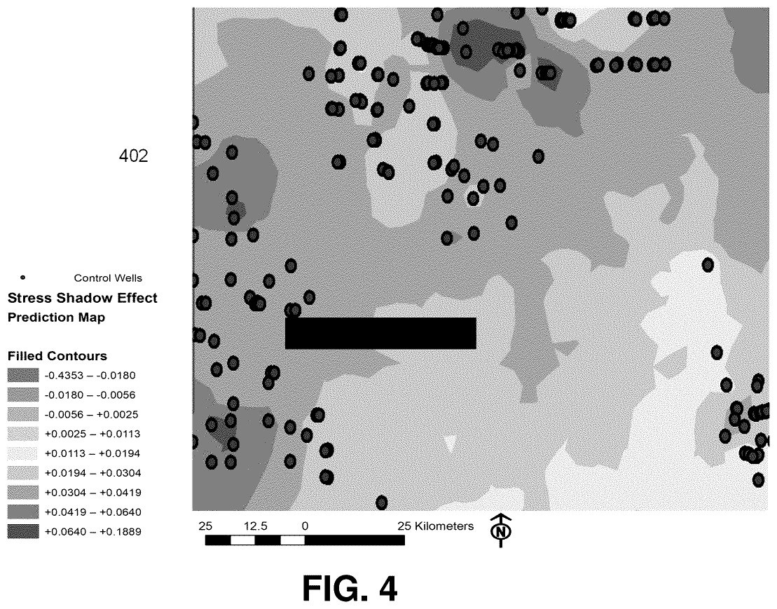

FIG. 4 is an example representation, in accordance with some implementations. 402 is a representation of the stress shadow effect as a function of position in the subsurface volume of interest. This is a map, in the X,Y domain (latitude, longitude). Spatial trends are observable in the map, with the rate of build in stress increasing from bottom to top of the map. Dots represent actual wells that may be used to generate spatially continuous stress shadow effect data. Darker regions indicate a higher stress shadow effect slope coefficient and more deformation and/or stress as a result of the fracturing of the well. Lighter regions indicate a lower stress shadow effect slope coefficient and less deformation and/or stress as a result of the fracturing of the well.

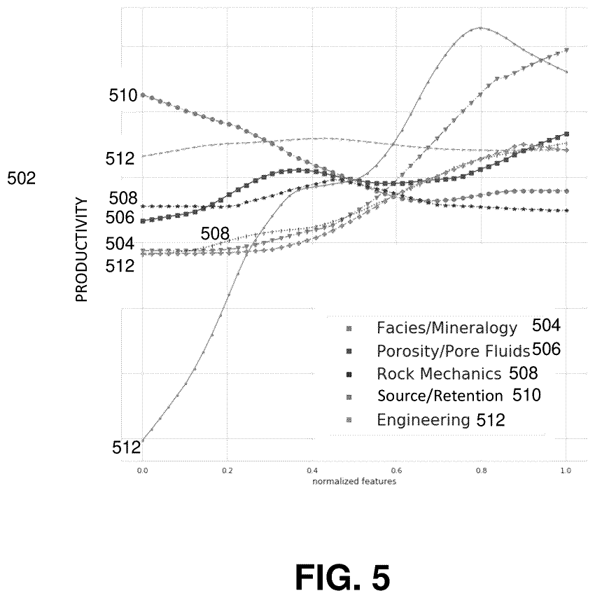

FIG. 5 illustrates a one-dimensional partial dependency of predictors, in accordance with some implementations. 502 illustrates the impact of various factors on productivity in a well. Line 504 represents the impact of the facies/mineralogy. Line 506 represents the impact of the porosity/pore fluids. Lines 508 represent the impact of the rock mechanics. Line 510 represents the impact of the source/retention. Lines 512 represent the impact of the engineering. Line 504 also represents the impact of the stress shadow effect. As can be seen the stress shadow effect can have as large of an impact as other factors, including number of fracture stages, brittleness, true vertical depth, fracture fluid intensity, gross perforated length, thickness, and/or others. While not shown, the stress shadow effect also has two-dimensional partial dependencies.

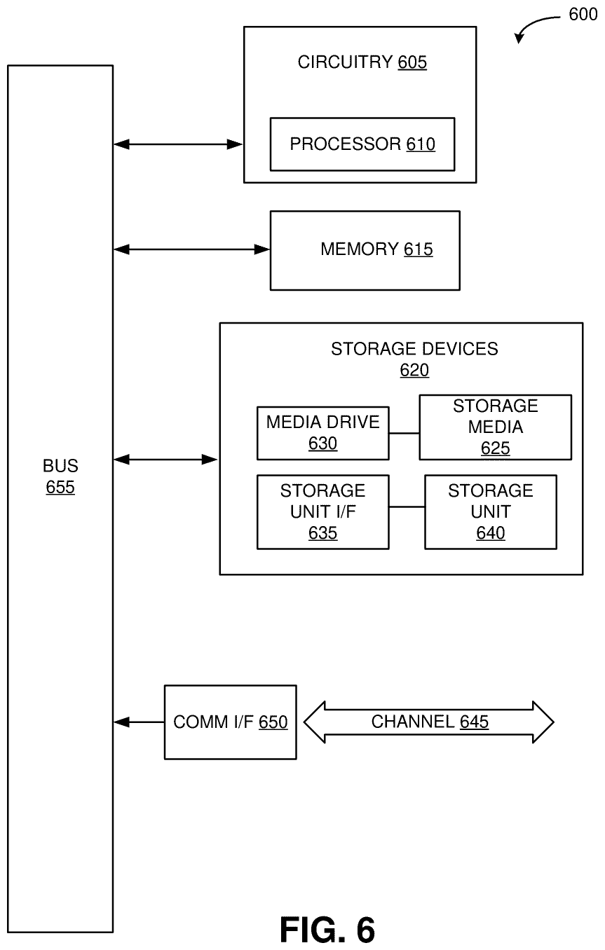

FIG. 6 illustrates example computing component 600, which may in some instances include a processor/controller resident on a computer system (e.g., server system 102). Computing component 600 may be used to implement various features and/or functionality of implementations of the systems, devices, and methods disclosed herein. With regard to the above-described implementations set forth herein in the context of systems, devices, and methods described with reference to FIGS. 1 through 5, including implementations involving server(s) 102, it may be appreciated additional variations and details regarding the functionality of these implementations that may be carried out by computing component 600. In this connection, it will also be appreciated upon studying the present disclosure that features and aspects of the various implementations (e.g., systems) described herein may be implemented with respect to other implementations (e.g., methods) described herein without departing from the spirit of the disclosure.

As used herein, the term component may describe a given unit of functionality that may be performed in accordance with some implementations of the present application. As used herein, a component may be implemented utilizing any form of hardware, software, or a combination thereof. For example, a processor, controller, ASIC, PLA, PAL, CPLD, FPGA, logical component, software routine, or other mechanism may be implemented to make up a component. In implementation, the various components described herein may be implemented as discrete components or the functions and features described may be shared in part or in total among components. In other words, it should be appreciated that after reading this description, the various features and functionality described herein may be implemented in any given application and may be implemented in separate or shared components in various combinations and permutations. Even though various features or elements of functionality may be individually described or claimed as separate components, it will be appreciated that upon studying the present disclosure that these features and functionality may be shared among a common software and hardware element, and such description shall not require or imply that separate hardware or software components are used to implement such features or functionality.

Where components of the application are implemented in whole or in part using software, in implementations, these software elements may be implemented to operate with a computing or processing component capable of carrying out the functionality described with respect thereto. One such example computing component is shown in FIG. 6. Various implementations are described in terms of example computing component 600. After reading this description, it will be appreciated how to implement example configurations described herein using other computing components or architectures.

Referring now to FIG. 6, computing component 600 may represent, for example, computing or processing capabilities found within mainframes, supercomputers, workstations or servers; desktop, laptop, notebook, or tablet computers; hand-held computing devices (tablets, PDA's, smartphones, cell phones, palmtops, etc.); or the like, depending on the application and/or environment for which computing component 600 is specifically purposed.

Computing component 600 may include, for example, a processor, controller, control component, or other processing device, such as a processor 610, and such as may be included in circuitry 605. Processor 610 may be implemented using a special-purpose processing engine such as, for example, a microprocessor, controller, or other control logic. In the illustrated example, processor 610 is connected to bus 655 by way of circuitry 605, although any communication medium may be used to facilitate interaction with other components of computing component 600 or to communicate externally.

Computing component 600 may also include a memory component, simply referred to herein as main memory 615. For example, random access memory (RAM) or other dynamic memory may be used for storing information and instructions to be executed by processor 610 or circuitry 605. Main memory 615 may also be used for storing temporary variables or other intermediate information during execution of instructions to be executed by processor 610 or circuitry 605. Computing component 600 may likewise include a read only memory (ROM) or other static storage device coupled to bus 655 for storing static information and instructions for processor 610 or circuitry 605.

Computing component 600 may also include various forms of information storage devices 620, which may include, for example, media drive 630 and storage unit interface 635. Media drive 630 may include a drive or other mechanism to support fixed or removable storage media 625. For example, a hard disk drive, a floppy disk drive, a magnetic tape drive, an optical disk drive, a CD or DVD drive (R or RW), or other removable or fixed media drive may be provided. Accordingly, removable storage media 625 may include, for example, a hard disk, a floppy disk, magnetic tape, cartridge, optical disk, a CD or DVD, or other fixed or removable medium that is read by, written to, or accessed by media drive 630. As these examples illustrate, removable storage media 625 may include a computer usable storage medium having stored therein computer software or data.

In alternative implementations, information storage devices 620 may include other similar instrumentalities for allowing computer programs or other instructions or data to be loaded into computing component 600. Such instrumentalities may include, for example, fixed or removable storage unit 640 and storage unit interface 635. Examples of such removable storage units 640 and storage unit interfaces 635 may include a program cartridge and cartridge interface, a removable memory (for example, a flash memory or other removable memory component) and memory slot, a PCMCIA slot and card, and other fixed or removable storage units 640 and storage unit interfaces 635 that allow software and data to be transferred from removable storage unit 640 to computing component 600.

Computing component 600 may also include a communications interface 650. Communications interface 650 may be used to allow software and data to be transferred between computing component 600 and external devices. Examples of communications interface 650 include a modem or softmodem, a network interface (such as an Ethernet, network interface card, WiMedia, IEEE 602.XX, or other interface), a communications port (such as for example, a USB port, IR port, RS232 port Bluetooth® interface, or other port), or other communications interface. Software and data transferred via communications interface 650 may typically be carried on signals, which may be electronic, electromagnetic (which includes optical) or other signals capable of being exchanged by a given communications interface 650. These signals may be provided to/from communications interface 650 via channel 645. Channel 645 may carry signals and may be implemented using a wired or wireless communication medium. Some non-limiting examples of channel 645 include a phone line, a cellular or other radio link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 615, storage unit interface 635, removable storage media 625, and channel 645. These and other various forms of computer program media or computer usable media may be involved in carrying a sequence of instructions to a processing device for execution. Such instructions embodied on the medium, are generally referred to as “computer program code” or a “computer program product” (which may be grouped in the form of computer programs or other groupings). When executed, such instructions may enable the computing component 600 or a processor to perform features or functions of the present application as discussed herein.

Various implementations have been described with reference to specific example features thereof. It will, however, be evident that various modifications and changes may be made thereto without departing from the broader spirit and scope of the various implementations as set forth in the appended claims. The specification and figures are, accordingly, to be regarded in an illustrative rather than a restrictive sense.

Although described above in terms of various example implementations and implementations, it should be understood that the various features, aspects, and functionality described in one of the individual implementations are not limited in their applicability to the particular implementation with which they are described, but instead may be applied, alone or in various combinations, to other implementations of the present application, whether or not such implementations are described and whether or not such features are presented as being a part of a described implementation. Thus, the breadth and scope of the present application should not be limited by any of the above-described example implementations.

Terms and phrases used in the present application, and variations thereof, unless otherwise expressly stated, should be construed as open ended as opposed to limiting. As examples of the foregoing: the term “including” should be read as meaning “including, without limitation,” or the like; the term “example” is used to provide illustrative instances of the item in discussion, not an exhaustive or limiting list thereof; the terms “a” or “an” should be read as meaning “at least one,” or the like; and adjectives such as “standard,” “known,” and terms of similar meaning should not be construed as limiting the item described to a given time period or to an item available as of a given time, but instead should be read to encompass standard technologies that may be available or known now or at any time in the future. Likewise, where this document refers to technologies that would be appreciated to one of ordinary skill in the art, such technologies encompass that which would be appreciated by the skilled artisan now or at any time in the future.

The presence of broadening words and phrases such as “at least,” “but not limited to,” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, may be combined in a single package or separately maintained and may further be distributed in multiple groupings or packages or across multiple locations.

Additionally, the various implementations set forth herein are described in terms of example block diagrams, flow charts, and other illustrations. As will be appreciated after reading this document, the illustrated implementations and their various alternatives may be implemented without confinement to the illustrated examples. For example, block diagrams and their accompanying description should not be construed as mandating a particular architecture or configuration.

What is claimed is:

1. A computer-implemented method for generating a stress shadow effect as a function of position in a subsurface volume of interest, the method being implemented in a computer system that includes a stress shadow detection circuit, a graphical user interface, and non-transient electronic storage, the method comprising:
obtaining completion data in the subsurface volume of interest from the non-transient electronic storage, wherein the completion data comprises hydraulic fracturing stage data and corresponding wellbore distances as a function of position, wherein individual sets of the corresponding wellbore distances correspond to individual wells;
generating, with the stress shadow detection circuit, relationships between the hydraulic fracturing stage data and the corresponding wellbore distances, wherein each of the relationships comprises a stress shadow effect slope coefficient representing an effect that fracturing a wellbore has on the subsurface volume of interest; and
generating spatially discrete stress shadow effect data by spatially attributing, with the stress shadow detection circuit, the stress shadow effect slope coefficient to locations of the individual wells, wherein the spatially discrete stress shadow effect data specifies the effect fracturing the wellbore is having on the subsurface volume of interest as a function of position.

2. The computer-implemented method of claim 1, further comprising: generating, with the stress shadow detection circuit, spatially continuous stress shadow effect data by using at least the spatially discrete stress shadow effect data to estimate stress shadow effect data between the spatially discrete stress shadow effect data.

3. The computer-implemented method of claim 2, further comprising:
generating a representation of the stress shadow effect as a function of position in the subsurface volume of interest using visual effects to depict at least a portion of the spatially continuous stress shadow effect data; and
displaying the representation in the graphical user interface.

4. The computer-implemented method of claim 2, wherein generating the spatially continuous stress shadow effect data comprises interpolation.

5. The computer-implemented method of claim 3, wherein the representation of the subsurface volume of interest is a temperature map.

6. The computer-implemented method of claim 1, wherein the completion data further comprises instantaneous shut down pressure (ISIP).

7. The computer-implemented method of claim 1, wherein the hydraulic fracturing stage data specifies a pressure value corresponding to a time at which the fluid pressure declines after injection.

8. The computer-implemented method of claim 1, wherein the relationships are generated using a stress shadow effect model.

9. The computer-implemented method of claim 8, wherein the stress shadow effect model comprises a regression analysis.

10. A system comprising:
non-transient electronic storage; and
a stress shadow detection circuit configured by machine-readable instructions to:
obtain completion data in the subsurface volume of interest from the non-transient electronic storage, wherein the completion data comprises hydraulic fracturing stage data and corresponding wellbore distances as a function of position, wherein individual sets of the corresponding wellbore distances correspond to individual wells;
generate, with the stress shadow detection circuit, relationships between the hydraulic fracturing stage data and the corresponding wellbore distances, wherein each of the relationships comprises a stress shadow effect slope coefficient representing an effect that fracturing a wellbore has on the subsurface volume of interest; and
generate spatially discrete stress shadow effect data by spatially attributing, with the stress shadow detection circuit, the stress shadow effect slope coefficient to locations of the individual wells, wherein the spatially discrete stress shadow effect data specifies the effect fracturing the wellbore is having on the subsurface volume of interest as a function of position.

11. The system of claim 10, wherein the stress shadow detection circuit is further configured by machine-readable instructions to: generate, with the stress shadow detection circuit, spatially continuous stress shadow effect data by using at least the spatially discrete stress shadow effect data to estimate stress shadow effect data between the spatially discrete stress shadow effect data.

12. The system of claim 11, further comprising a graphical user interface, wherein the stress shadow detection circuit is further configured by machine-readable instructions to:
generate a representation of the stress shadow effect as a function of position in the subsurface volume of interest using visual effects to depict at least a portion of the spatially continuous stress shadow effect data; and
display the representation in the graphical user interface.

13. The system of claim 11, wherein generating the spatially continuous stress shadow effect data comprises interpolation.

14. The system of claim 12, wherein the representation of the subsurface volume of interest is a temperature map.

15. The system of claim 10, wherein the completion data further comprises ISIP.

16. The system of claim 10, wherein the hydraulic fracturing stage data specifies a pressure value corresponding to a time at which the fluid pressure declines after injection.

17. The system of claim 10, wherein the relationships are generated using a stress shadow effect model.

18. The system of claim 17, wherein the stress shadow effect model comprises a regression analysis.

19. A non-transitory machine-readable storage media storing instructions that, when executed by a stress shadow detection circuit, cause the stress shadow detection circuit to:
obtain completion data in the subsurface volume of interest from the non-transient electronic storage, wherein the completion data comprises hydraulic fracturing stage data and corresponding wellbore distances as a function of position, wherein individual sets of the corresponding wellbore distances correspond to individual wells;
generate, with the stress shadow detection circuit, relationships between the hydraulic fracturing stage data and the corresponding wellbore distances, wherein each of the relationships comprises a stress shadow effect slope coefficient representing an effect that fracturing a wellbore has on the subsurface volume of interest; and
generate spatially discrete stress shadow effect data by spatially attributing, with the stress shadow detection circuit, the stress shadow effect slope coefficient to locations of the individual wells, wherein the spatially discrete stress shadow effect data specifies the effect fracturing the wellbore is having on the subsurface volume of interest as a function of position.

20. The non-transitory machine-readable storage media of claim 19, wherein the non-transitory machine-readable storage media stores further instructions that, when executed by the stress shadow detection circuit, cause the stress shadow detection circuit to: generate, with the stress shadow detection circuit, spatially continuous stress shadow effect data by using at least the spatially discrete stress shadow effect data to estimate stress shadow effect data between the spatially discrete stress shadow effect data.

21. The non-transitory machine-readable storage media of claim 20, wherein the non-transitory machine-readable storage media stores further instructions that, when executed by the stress shadow detection circuit, cause the stress shadow detection circuit to:
generate a representation of the stress shadow effect as a function of position in the subsurface volume of interest using visual effects to depict at least a portion of the spatially continuous stress shadow effect data; and
display the representation in a graphical user interface.

22. The non-transitory machine-readable storage media of claim 20, wherein generating the spatially continuous stress shadow effect data comprises interpolation.

23. The non-transitory machine-readable storage media of claim 21, wherein the representation is a temperature map.

24. The non-transitory machine-readable storage media of claim 19, wherein the completion data further comprises ISIP.

25. The non-transitory machine-readable storage media of claim 19, wherein the hydraulic fracturing stage data specifies a pressure value corresponding to a time at which the fluid pressure declines after injection.

26. The non-transitory machine-readable storage media of claim 25, wherein the relationships are generated using a stress shadow effect model, and wherein the stress shadow effect model comprises a regression analysis.
